(19) United States
(12) Patent Application Publication
(10) Pub. No.: US 2018/0185127 A1
(43) Pub. Date: Jul. 5, 2018

(54) Prophy Cartridge System

(71) Applicant: George Michel Mansour, Diamond Bar, CA (US)

(72) Inventor: George Michel Mansour, Diamond Bar, CA (US)

(21) Appl. No.: 15/860,033

(22) Filed: Jan. 2, 2018

Related U.S. Application Data
(60) Provisional application No. 62/441,906, filed on Jan. 3, 2017.

(51) Int. Cl. A61C 17/028; A61C 17/02; A61C 17/00; A46B 11/00; A61C 1/05; A61C 1/00; A61C 1/12

(52) U.S. Cl. CPC A61C 17/028; A61C 17/0205; A61C 17/0202; A61C 17/005; A46B 2200/00; A61C 1/052; A61C 1/0084; A61C 1/12; A46B 11/001

(57) ABSTRACT

A prophy angle system includes a the prophy angle, a hand piece configured to drive a central shaft within the prophy angle, means within the hand piece for advancing at least one push rod from a distal end of the hand piece, and a paste cartridge configured to fit within the cavity of the prophy angle without interfering with rotation of the central shaft, the cartridge including a plunger positioned at a proximal end of the cartridge such that when the at least one push rod pushes against the plunger in a distal direction, paste may be dispensed distally through the cavity in the prophy angle and into the prophy cup.

### RELATED APPLICATION

The present application claims priority to provisional patent application U.S. Ser. No. 62/441,906 filed on Jan. 3, 2017, the entire contents of which is herein incorporated by reference

### BACKGROUND

The present invention relates to a system for facilitating the loading of paste within a prophy angle driven by a corded or cordless hand piece.

### SUMMARY

Embodiments of the present invention include a system for the dispensing of paste from within a prophy angle, where in one embodiment the system comprises a prophy angle comprising a housing and a cavity therewithin, the prophy angle further comprising a central shaft mechanically linked to a prophy cup at a distal end of the prophy angle such that rotation of the central shaft causes rotation of the prophy cup, the prophy angle comprising a plurality of gears positioned within the prophy angle such that discharge of paste from within the prophy angle to the prophy cup does not engage nor interfere with the gears; a hand piece configured to drive the central shaft as desired by a user, the hand piece comprising means for advancing at least one push rod from a distal end of the hand piece; and a paste cartridge configured to fit within the cavity of the prophy angle without interfering with rotation of the central shaft, the cartridge comprising a plunger positioned at a proximal end of the cartridge such that when the at least one push rod pushes against the plunger in a distal direction, paste may be dispensed distally through the cavity in the prophy angle and into the prophy cup, wherein when a user activates the advancing means of the hand piece, paste may be discharged to the patient's teeth while the prophy cup is spinning.

In one embodiment, the advancing means comprises a manual lever that is configured to be depressed manually by a user, and wherein the lever is further configured to engage a plate that itself is configured to drive the at least one push rod distally forward when it is desired to dispense paste. In an alternative embodiment, the advancing means comprises a motor that is configured to engage a plate that itself is configured to drive the at least one push rod distally forward when it is desired to dispense paste. The motor may be activated by a button, or the motor may be activated by a drive system associated with driving the central shaft of the prophy angle.

In one embodiment, the system further comprises means for securing the prophy angle to the hand piece. In one example, the securing means comprises at least one aperture and a compressible button. In another example, the securing means comprises at least one angled slot and a button.

In one embodiment, a prophy system comprises a paste cartridge configured to be placed within the cavity of a prophy angle, the paste cartridge comprising a plunger that can be activated such that paste is pushed out of the cartridge into the cavity of the prophy angle. The system may further comprise a prophy angle comprising a cavity into which the paste cartridge can be positioned for the dispensing of paste. The prophy angle preferably comprises a prophy cup that configured so that paste may be delivered through the prophy cup to a patient's teeth. In one embodiment, the prophy system further comprises a hand piece with advancing means configured to advance the plunger of the paste cartridge

Methods are also contemplated herein. In one application, a method is provided for the advancement of paste through a prophy angle, the method comprising inserting a paste cartridge into a cavity of a prophy angle, the cartridge comprising a plunger and a supply of paste, the prophy angle comprising a prophy cup having a tube therein for the passage of paste through the prophy cup, the method further comprising connecting the prophy angle and cartridge to a hand piece configured to drive rotation of the prophy cup, and activating means for advancing the paste within the cartridge so as to direct the paste through the passage of the prophy cup. In some embodiments, the advancing means comprises at least one push rod configured to push against the plunger in the cartridge to push paste out of the cartridge into the prophy angle cavity and through the prophy cup passage. The advancing means may comprise a manual lever, or an automated motor.

### BRIEF DESCRIPTION OF THE FIGURES

The aforementioned objects and advantages of the present invention, as well as additional objects and advantages thereof, will be more fully understood hereinafter as a result of a detailed description of a preferred embodiment when taken in conjunction with the following drawings in which:

FIG. 1 shows an elevational schematic view of one embodiment of the present invention;

FIG. 2 shows perspective schematic views of one embodiment of a paste cartridge for use with embodiments such as that shown in FIG. 1;

FIG. 3 shows an elevational schematic view of the embodiment of FIG. 1;

FIG. 4 shows elevational schematic views of the embodiment of FIG. 1 in sequence;

FIG. 5 shows elevational schematic views of the embodiment of FIG. 1 in sequence;

FIG. 6 shows elevational schematic views of the embodiment of FIG. 1 in sequence;

FIG. 7 shows an elevational schematic view of an alternative embodiment;

FIG. 8 shows an elevational schematic view of an alternative embodiment;

FIG. 9 shows an elevational schematic view of an alternative embodiment.

### DETAILED DESCRIPTION OF CERTAIN EMBODIMENTS

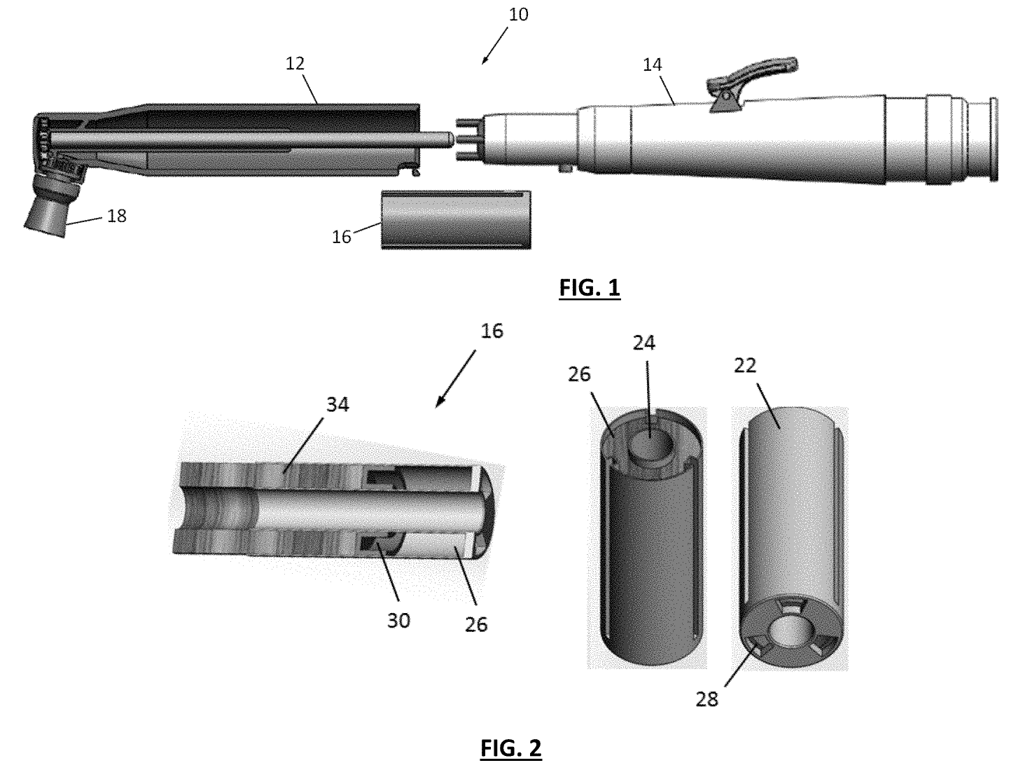

By way of example, and referring to FIG. 1, one embodiment of the present system 10 comprises a prophy angle 12, a hand piece 14 and a paste cartridge 16 configured to fit within an interior of the prophy angle 12, and further configured to be driven by the hand piece 14. The prophy angle 12 may be of any size and shape, but is preferably configured to have an interior housing to accommodate a paste cartridge, such as that shown at 16. The prophy angle 12 is further preferably configured so that paste can be dispensed from the cartridge 16 through a channel within the prophy angle 12 and delivered into a cup 18 at the distal end of the prophy angle 12. By doing so, paste may be dispensed by a dental clinician onto a patient's teeth as desired while the cup is spinning. In that regard, the spinning of the cup, as is typical with many prophy angles and hand pieces, is driven by the hand piece, which may be corded or cordless.

Referring to FIG. 2, the cartridge 16 can be of any shape or size, but is preferably configured to fit within an interior chamber of the prophy angle 12 so that paste can be dispensed through the prophy angle 12 into prophy cup 18 for delivery to a patient's teeth. In one embodiment, such as that shown in FIG. 2, the cartridge 16 comprises a generally cylindrical housing 22 having a central bore 24 therethrough and a cavity 26 defined by an outer wall of the housing 22 and the central bore 24 into which paste can be stored. At one end of the cartridge, openings 28 are provided that correspond with pusher rods associated with the hand piece (not shown), as discussed below. Preferably, a plunger 30 is positioned within the cavity 26 to drive paste 34 in a distal direction as it is desired to dispense paste during use. Preferably, the paste 34 is sealed within cartridge 16 until it is ready for use, at which time the seal can be removed and the cartridge inserted into the prophy angle for use. The seal may comprise a layer of materially adhered to the edges of the distal end of the cartridge, and can be peeled away from it is desired to expose the paste. Other means for sealing the paste are contemplated as well.

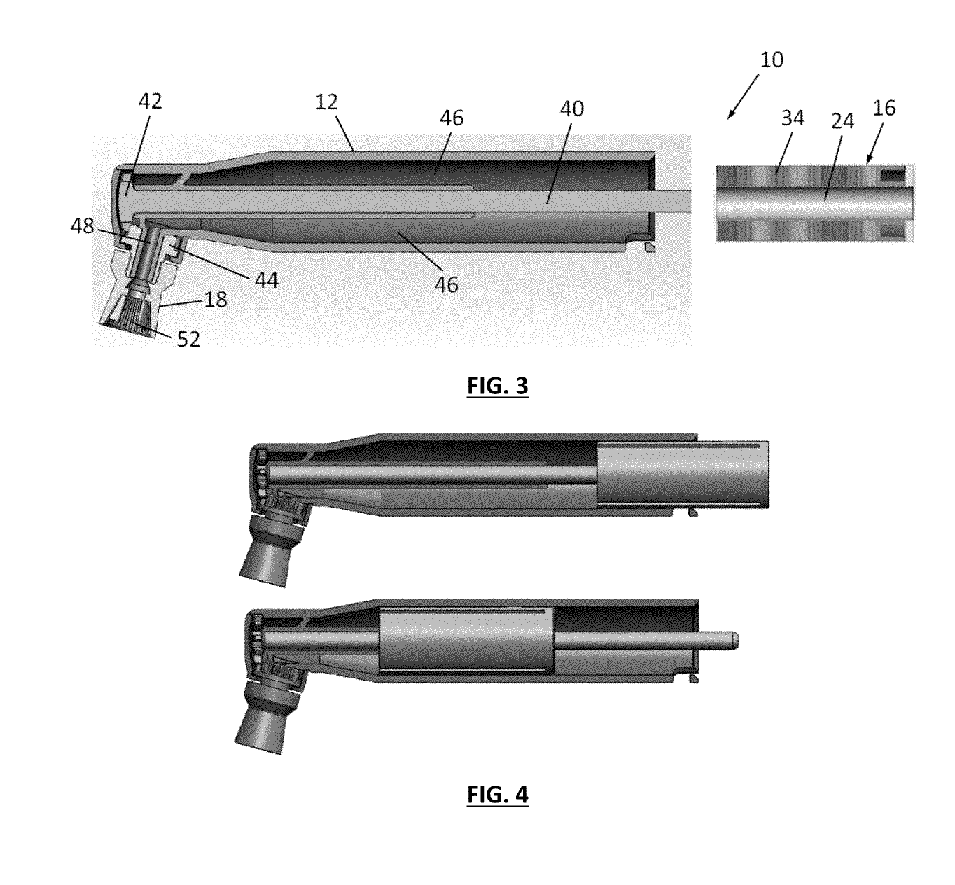

Referring to FIGS. 3 and 4, the prophy angle 12 comprises a central shaft 40 having a gear 42 at its distal end, which gear 42 is configured to be meshed with gear 44 connected to prophy cup 18. When central shaft 40 spins, it drives cup 18 through gears 42, 44. The central shaft 40 is positioned within a cavity 46 of prophy angle 12 into which a cartridge, such as cartridge 16, can be placed. In that regard, the central bore 24 of the cartridge 16 is sized to fit over central shaft 40 without inhibiting rotational movement of the central shaft 40. The hand piece 14 is configured to rotationally drive the central shaft 40 of the prophy angle 12 so that during use a dental clinician can dispense paste through a rotating prophy cup to clean a patient's teeth. The cartridge 16 may be inserted into a proximal end of the prophy angle 12 such that the bore 24 slides over the central shaft 40, and may be pushed forward toward the distal end of the prophy angle. When paste 34 is dispensed from the cartridge 16, it preferably passes through a distal end of cavity 46 into tubular portion 48 and out through an opening 52 in the prophy cup 18 without interfering with gears 42, 44.

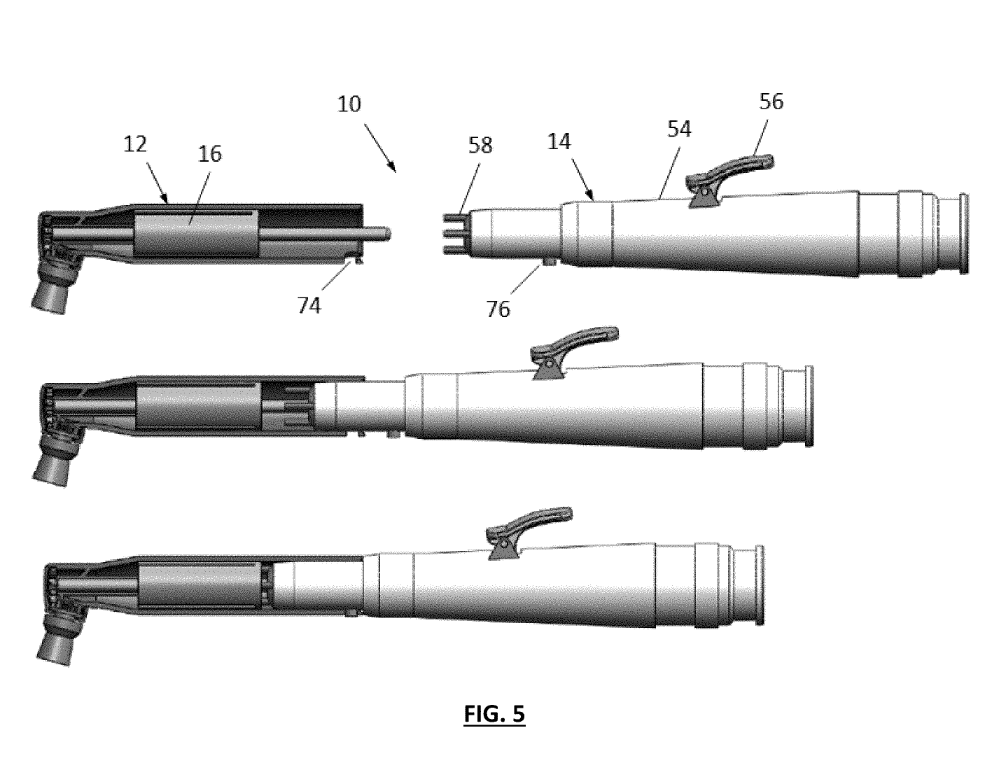

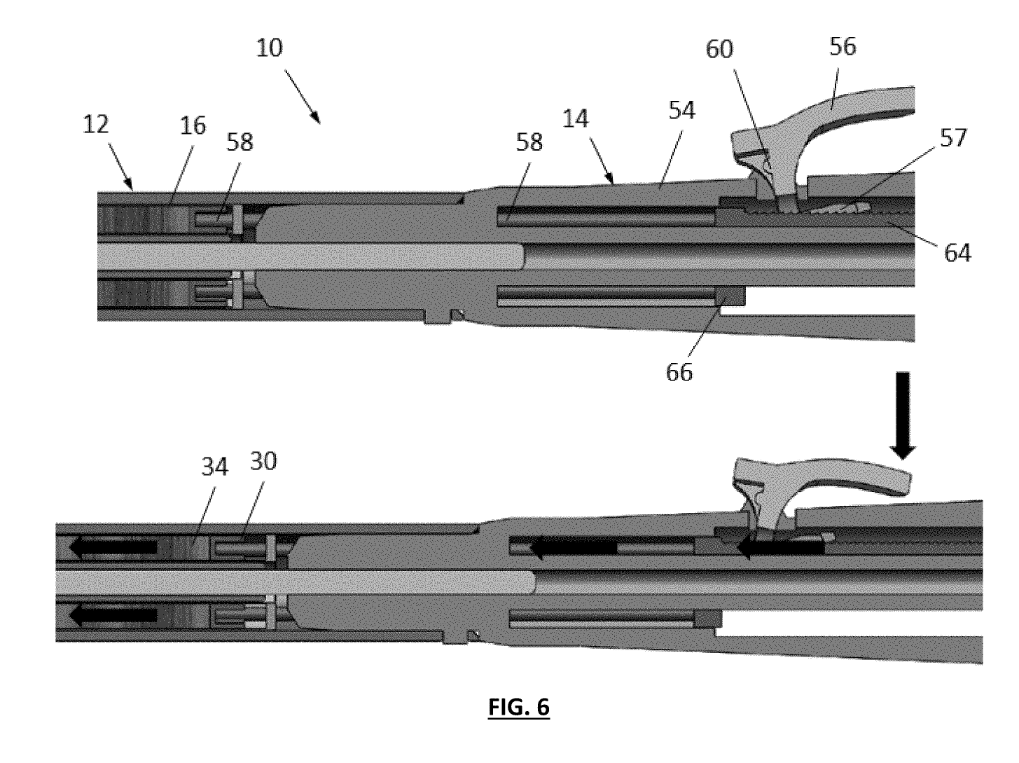

Referring to FIG. 5, hand piece 14 can be configured to function manually, semi-automatically, or automatically, as described below. In an embodiment, such as that shown in FIG. 5, the hand piece 14 may be manually operated via an activating (or advancing) means, such as a lever depressible by the clinician during use. In that regard, in one example, hand piece 14 may comprise a housing 54 and pivotable lever 56 that, when depressed, controls distal projecting push rods 58. A single rod is also contemplated. Preferably, the prophy angle 12 and hand piece 14 are configured so that the distal end of the hand piece 14 can be inserted into the proximal end of the prophy angle 12, as shown in FIG. 5. By bringing the hand piece 14 into engagement with the prophy angle 12, the push rods 58 can be brought into engagement with the openings 28 in the proximal end of the cartridge 16 for engagement with the plunger 30 to push paste 34 from the cartridge 16, as further shown in FIG. 6. The lever 56 is preferably configured to pivot about a pivot point 60 and is spring loaded to return to a non-depressed position. The lever further comprises an extension 57 configured to engage teeth of a gear plate 64 such that depression of the lever 56 causes extension 57 to engage at least one tooth of the gear plate 64 so that continued pivoting of the lever drives the gear plate 64 forward, thereby driving the push rods 58 forward against plunger 30 within cartridge 16. When the lever is released, the spring returns the lever to its normal undepressed position, and the extension is released to the next proximal tooth in the gear plate 64. Successive depressing and releasing of the lever 56 causes gear plate 64 to continue to move forward and drive the plunger 30 more distal within the cartridge 16, thereby forcing paste 34 out of the cartridge in a distal direction within the prophy angle 12 toward prophy cup 18.

It is contemplated that a means for locking the prophy angle 12 to the hand piece 14 is provided. Referring to FIG. 5, for example, in one embodiment, an opening 74 is provided at the proximal end of the prophy angle 12, where the opening 74 is configured to permit a compressible button 76 on the proximal end of the hand piece to fit within the opening 74. Such a lock configuration not only keeps the prophy angle and hand piece connected, but prevents undesired rotation of the prophy angle relative to the hand piece during use. A slot may be provided instead of an opening, and the button need not be compressible.

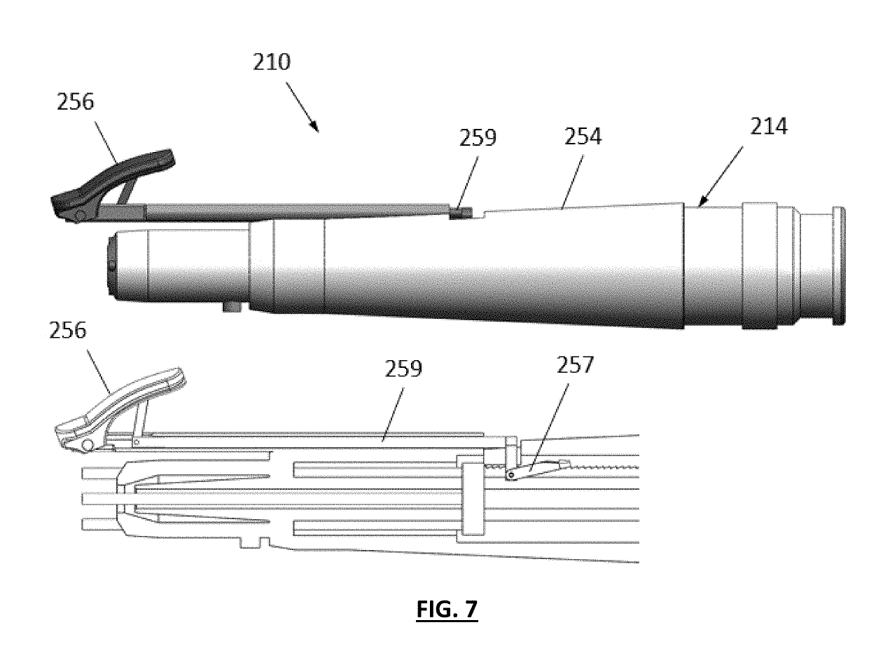

The configuration of the lever, spring, extension, and gear plate may vary from embodiment to embodiment depending upon the needs or desires of the clinician to facilitate dispensing of paste. The lever also may be placed closer or further away from the prophy angle, also as desired for effective operation. For example, referring to FIG. 7, embodiment 210 comprises a hand piece 214 that has a pivotable lever 256 on housing 254 positioned distally, wherein the pivotable lever 256 is connected to an extension 257 via mechanical linkage 259. In that regard, the extension 257 works similarly to the extension 57 described above. Other means for advancing push rods (or other mechanisms) are contemplated other than the system as shown and described herein.

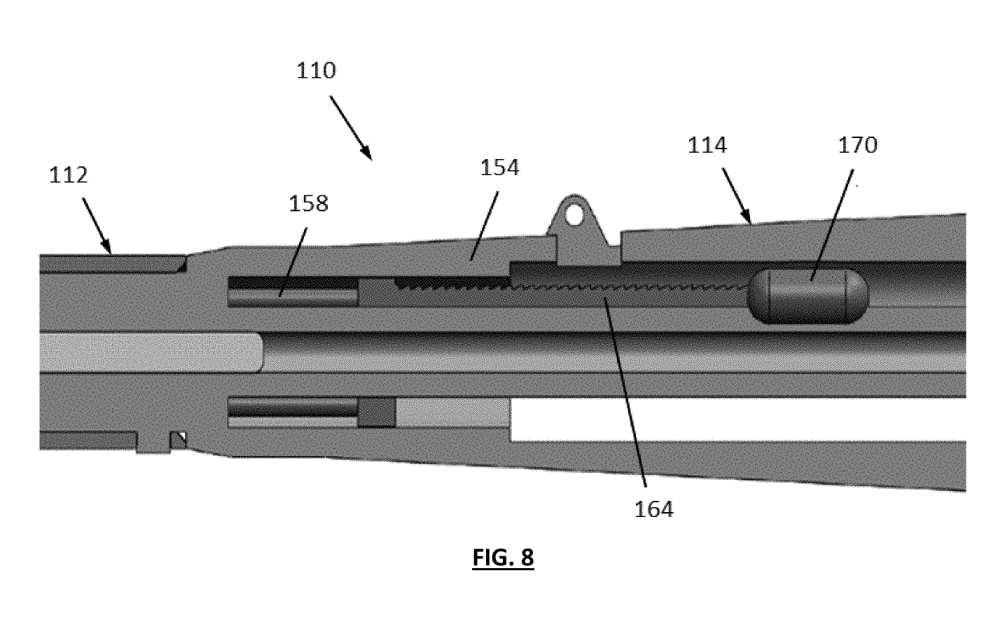

Referring back to FIGS. 1-6, as appropriate, seals may be positioned at one or more places within the prophy angle so that paste is directed appropriately from the cartridge through the prophy angle to the central opening 52 of the prophy cup 18 for the discharge of paste to the patient's teeth. The seals should preferably be positioned to minimize risk of the paste contacting the gears 42 and 44.

Where it is desired that the hand piece operate semi-automatically or completely automatically, a manual lever need not be employed. Rather, as shown in FIG. 8, a motor can be provided within the hand piece to drive the push rods distally. In that regard, in one embodiment of such a system, such as that shown in FIG. 8, system 110 may comprise an automated a prophy angle 112 and a hand piece 114. Hand piece 114 comprises housing 154 and one or more push rods 158 secured to a gear plate 164 driven by motor 170. The motor may be configured to turn automatically when activated at a certain rate to drive the gear plate distally forward at a rate suitable for the dispensing of paste during a cleaning. In such an arrangement, the motor 170 may be linked (mechanically, electrically or a combination of both) to the drive system (not shown) for driving the central shaft of the prophy angle so that when the drive system is running, the motor 170 runs as well, preferably at a pre-set rate for suitable discharge of paste.

In a semi-automated arrangement, an on/off button may be provided on the hand piece to permit the clinician to activate the motor 170 when it is desired that paste be dispensed. The on/off button can be configured with two positions, one for on and one for off, or it can be configured so that it is normally in an off position, but can be moved by the user to an on position for as long as the clinician holds the button in place. Other arrangements are also contemplated for the automated driving of paste from the cartridge within the prophy angle. In either case, the drive system that drives the central shaft and ultimately the prophy cup is such that it may be contained within the hand piece when the hand piece is configured to be cordless. Or the drive system may be externally located with the hand piece is corded. The drive system may be mechanically, hydraulic or pneumatic driven.

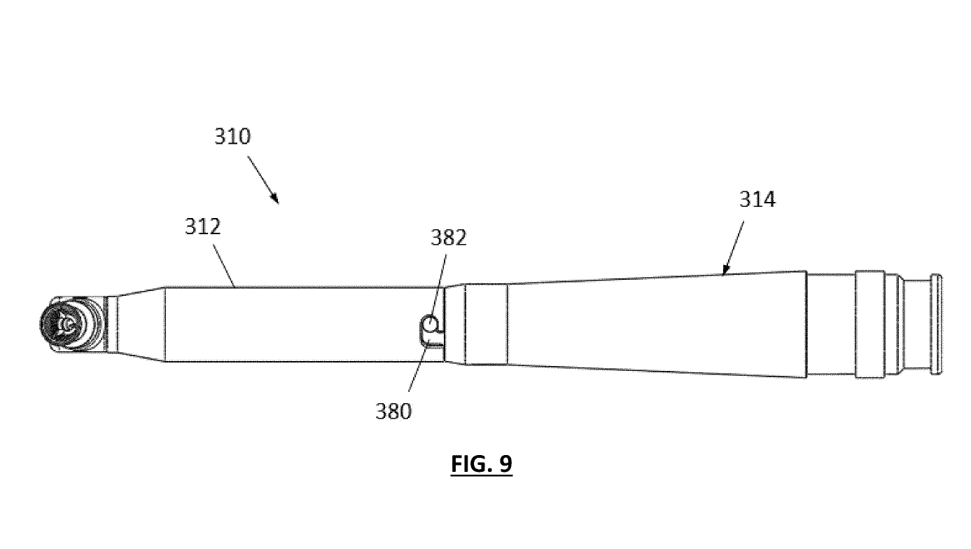

In some contemplated embodiments, the prophy angle system comprises a securing means configured specifically such that the prophy angle fits only with a mating hand piece of the types described and/or contemplated herein. In some cases, such specific configurations have the advantage of securing the prophy angle to the hand piece. For example, referring to FIG. 9, embodiment 310 comprises a prophy angle 312 and hand piece 314, where the system comprises a securing means. For example, prophy angle may comprise an angled slot, e.g., an L-shaped slot 380, and the hand piece may comprise a button 382. It is contemplated that there be one securing means (e.g., one pair of slot and button), or multiple securing means (e.g., multiple pairs of slot and button), as desired. Other means of mating/securing the prophy angle to the hand piece are contemplated that maximize the likelihood that the prophy angle is usable only with the hand piece embodiments described and/or contemplated herein. For example, a proximal mating edge of the hand piece and the distal mating edge of the prophy angle may both be sinusoidal so as to closely mate the two together in alignment. Other profiles are contemplated in addition to sinusoidal profiles. A lock mechanism (securing means) could also be used.

Methods for the advancement of paste through a prophy angle are also contemplated by applications the invention herein. In one embodiment, for example, and with reference to FIGS. 1-6, a method comprises inserting the paste cartridge 16 into the cavity 46 of the prophy angle 12, connecting the prophy angle 12 and cartridge 16 to a hand piece 14 configured to drive rotation of the prophy cup 18, and activating a device or means for advancing the paste within the cartridge so as to direct the paste through the passage of the prophy cup, which includes, by way of example only, the manual lever discussed above or the motor discussed above. The advancing means comprises at least one push rod 58 configured to push against the plunger 30 in the cartridge 16 to push paste 34 out of the cartridge into the prophy angle cavity and through the prophy cup passage.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A system for the dispensing of paste from within a prophy angle, the system comprising:
a prophy angle comprising a housing and a cavity therewithin, the prophy angle further comprising a central shaft mechanically linked to a prophy cup at a distal end of the prophy angle such that rotation of the central shaft causes rotation of the prophy cup, the prophy angle comprising a plurality of gears positioned within the prophy angle such that discharge of paste from within the prophy angle to the prophy cup does not engage nor interfere with the gears;
a hand piece configured to drive the central shaft as desired by a user, the hand piece comprising means for advancing at least one push rod from a distal end of the hand piece; and
a paste cartridge configured to fit within the cavity of the prophy angle without interfering with rotation of the central shaft, the cartridge comprising a plunger positioned at a proximal end of the cartridge such that when the at least one push rod pushes against the plunger in a distal direction, paste may be dispensed distally through the cavity in the prophy angle and into the prophy cup,
wherein when a user activates the advancing means of the hand piece, paste may be discharged to the patient's teeth while the prophy cup is spinning.

2. The system of claim 1, wherein the advancing means comprises a manual lever that is configured to be depressed manually by a user, and wherein the lever is further configured to engage the at least one push rod distally forward when it is desired to dispense paste.

3. The system of claim 1, where the advancing means comprises a motor that is configured to engage the at least one push rod distally forward when it is desired to dispense paste.

4. The system of claim 3, wherein the motor may be activated by a button.

5. The system of claim 3, wherein the motor may be activated by a drive system associated with driving the central shaft of the prophy angle.

6. The system of claim 1, further comprising means for securing the prophy angle to the hand piece.

7. The system of claim 6, wherein the securing means comprises at least one aperture and a compressible button.

8. The system of claim 6, where the securing means comprises at least one angled slot and a button.

9. A prophy system comprising a paste cartridge configured to be placed within the cavity of a prophy angle, the paste cartridge comprising a plunger that can be activated such that paste is pushed out of the cartridge into the cavity of the prophy angle.

10. The system of claim 9, further comprising a prophy angle comprising a cavity into which the paste cartridge can be positioned for the dispensing of paste.

11. The system of claim 10, wherein the prophy angle comprises a prophy cup that configured so that paste may be delivered through the prophy cup to a patient's teeth.

12. The system of claim 9, further comprising a hand piece with advancing means configured to advance the plunger of the paste cartridge.

13. A method for the advancement of paste through a prophy angle, the method comprising inserting a paste cartridge into a cavity of a prophy angle, the cartridge comprising a plunger and a supply of paste, the prophy angle comprising a prophy cup having a tube therein for the passage of paste through the prophy cup, the method further comprising connecting the prophy angle and cartridge to a hand piece configured to drive rotation of the prophy cup, and activating means for advancing the paste within the cartridge so as to direct the paste through the passage of the prophy cup.

14. The method of claim 13, wherein the advancing means comprises at least one push rod configured to push against the plunger in the cartridge to push paste out of the cartridge into the prophy angle cavity and through the prophy cup passage.

15. The method of claim 13, wherein the advancing means comprises a manual lever.

16. The method of claim 13, wherein the advancing means comprises a motor.
